(19) United States
(12) Patent Application Publication
(10) Pub. No.: US 2015/0175763 A1
(43) Pub. Date: Jun. 25, 2015

(54) NATURAL FIBRE AND METHOD OF PRODUCTION AND USE IN MODULAR CONSTRUCTION

(71) Applicant: Sunkeeper Limited, Stroud Gloucestershire (GB)

(72) Inventors: John Kinmount, Stroud Gloucestershire (GB); David Binns, Stroud Gloucestershire (GB)

(21) Appl. No.: 14/404,605

(22) PCT Filed: May 29, 2013
(86) PCT No.: PCT/GB2013/051423

§ 371 Date: Nov. 28, 2014

(30) Foreign Application Priority Data
May 30, 2012 (GB) 1209572.5
May 31, 2012 (GB) 1209747.3
Sep. 19, 2012 (GB) 1216689.8

(51) Int. Cl. C08J 9/00; C08J 9/10

(52) U.S. Cl. CPC C08J 9/0085; C08J 9/103; C08J 9/0061; C08J 2397/00; C08J 2423/06; C08J 2203/04

(57) ABSTRACT

The present invention provides a method of producing reinforced composite containing fibre in a polymer matrix comprising the steps of: a. heating and drying a natural fibre-containing material in a hot blending chamber; b. sieving the dried natural fibre-containing material to produce a loose, soft and clean natural fibre free of contaminants and unwanted elements; c. shredding the fibre; d. pre-heating the shredded fibre; e. blending polymer, a nitrogen blowing agent a lubricant with the shredded fibre and optionally a coupling agent; and f. heating the blended mixture to the melting point of the polymer. Also provided is a composite produced by the method and a composite comprising a natural fibre-containing material, a polymer, a nitrogen blowing agent, a lubricant and optionally a coupling agent. Various modular constructions and a weighing assembly made from the composite are also provided.

### BACKGROUND TO THE INVENTION

The present invention relates to a reinforced composite containing natural fibre in a polymer matrix and its method of production. In particular, the present invention relates to a reinforced composite that incorporates rice husk rather than wood dust and whose method of production includes the use of a nitrogen blowing agent. The invention also relates to a modular construction and sensing assembly made from the reinforced composite

Finding new solutions to waste disposal has become more and more important as the amount of waste generated by society has increased as a result of expanding populations and an associated increase in consumerism. Existing methods of waste disposal include the dumping of waste in landfill sites. However, this has a serious environmental impact, even when the waste involved is natural or organic waste and does not carry any toxicity risk. For example, the disposal of organic waste in landfill sites is a problem where the waste gradually degrades, causing future subsidence to the land and any buildings/roadways that have been erected on the land. Furthermore, methane production during the degradation process can be problematic and is subject to increasing regulatory controls.

An alternative, and popular, means of disposal of organic waste is to burn it. However, the resultant smoke pollutes the immediate environment, which is both potentially harmful to health and can often have an antisocial impact on populations within the immediate and neighbouring vicinities. In addition, the combustion process results in the release of significant amounts of carbon dioxide into the atmosphere which is commonly accepted as contributing to global warming and other undesirable environmental effects.

One particular form of natural waste is natural fibre-containing material. An example of this is rice husk and rice husk ash (a by-product from the burning of rice husk). Rice husk is extremely prevalent in East and South-East Asia as a result of the high levels of rice production in these areas. When the rice is harvested, the rice is removed from the husk before being sold. A proportion of the rice husk produced annually is then burned in kilns and used as a form of energy, with the resultant production of rice husk ash. However, rice husk is difficult to ignite and does not burn easily with an open flame unless air is blown through the husk therefore efficient burning of rice husk as a means of waste disposal or a source of energy can be difficult. Furthermore, the production of rice husk ash via combustion has a detrimental environmental effect as discussed above. Finally, combustion of rice husk is not a practical solution for total rice husk disposal as over 130 million tons of rice husk waste is generated per year, which is clearly too large an amount for safe combustion without severe environmental impact.

As the general awareness of the environment impact of the disposal of natural waste increases, it has become clear that one way of avoiding the undesirable effects of waste disposal methods such as combustion is to recycle the waste, where possible. This is also of escalating importance as population sizes increase and the natural available resources decline.

However, when recycling natural fibre waste it is important to recognise that undesirable moisture or other volatile fluids present in the fibre waste may cause irregularities in the fibre cell structures thereby compromising the strength of any end product of the recycling process. In addition the presence of unwanted foreign material or particles in the waste fibre has the potential to greatly weaken the linkages between the fibres and the polymer matrices. Therefore the recycling process has to take these potential problems into account and the processing conditions at each stage must be carefully controlled to ensure that there is no compromise in the strength of the process end product that may affect its strength and therefore onward application.

There is therefore a need for an effective method of recycling natural fibre waste that has minimal environmental impact and effectively disposes of fibre waste in an efficient manner to produce a useful end product.

### SUMMARY OF THE INVENTION

The present invention seeks to address the problems of the prior art.

Accordingly, a first aspect of the present invention provides a method of producing reinforced composite containing natural fibre in a polymer matrix comprising the steps of:
a. heating and drying a natural fibre-containing material in a hot blending chamber;
b. sieving the dried fibre-containing material to produce a loose, soft and clean natural fibre free of contaminants and unwanted elements;
c. shredding the fibre;
d. pre-heating the shredded fibre;
e. blending polymer, a nitrogen blowing agent and a lubricant with the shredded fibre; and
f. heating the blended mixture to the melting point of the polymer.

Preferably, step e also involves the addition of a coupling agent. The coupling agent may be any suitable coupling agent including, but not restricted to, glycidyl methacrylate.

In one embodiment, the natural fibre-containing material comprises rice husk fibre. However, it is to be appreciated that any natural fibre or natural fibre mix may be used in the above method.

In a further embodiment, the natural fibre consists mainly of rice husk fibre and preferably consists of rice husk fibre to the exclusion of other natural fibres.

The blowing agent may be any suitable nitrogen or carbon dioxide blowing agent such as, but not limited to, azodicarbonamide, p-toluenesulfonylhydrazide, 4,4-oxybisbenzenesulfonylhydrazide, 5-phenyltetrazole and sodium bicarbonate/citric acid.

The rice husk material is preferably heated in a hot blending chamber to about 110° C. to eliminate moisture and/or any volatile matter present, and also to soften lignin in the natural-fibre containing material. The hot blending chamber may be of any suitable design known to the skilled person, but preferably includes a heating oil reservoir which is electrically heated by heater rods and plates—this provides a stable and efficient heat throughout the drying process. In one embodiment, the blending chamber comprises an outer spiral ribbon which conveys the natural fibre-containing material in one direction, and an inner spiral ribbon which conveys the natural fibre-containing material in an opposing direction. This action results in distributive heating of the natural fibre-containing material throughout the hot blending chamber. The drying process is considered complete when the natural fibre-containing material in the hot blending chamber reaches around 110° C., which is when any moisture or volatile matter likely to be present will have been eliminated. This heating step results in a softening of the lignin within the natural fibre-containing material, thereby facilitating the next step in the method of the present invention.

The sieving step produces a loose, soft, dry and clean natural fibre which is desirable as it reduces the duration of the densification/shredding step and increases the efficiency of the method.

After sieving, the fibre is densified by shredding before being pre-heated, for example, in a suitable blending apparatus. The shredding is preferably carried out at around 100° C. to produce dry and fine natural fibre strand. The pre-heating step prior to blending is preferably also carried out at around 100° C. The densification step serves to abrade the natural fibre strand into shorter lengths, softens the fibre lignin and further eliminates any residual volatile substances.

During the blending process, the use of a suitable plastic resin or combination of resins together with the selected lubricant and the selected coupling agent ensures the optimum dispersion levels of fibres during the process. This is desirable as it maximises the strength of the linkages between the fibres and the polymer matrices, resulting in a stronger end product.

The addition of lubricant along with the polymer serves to improve the dispersability of the polymer within the natural fibres, as one of the observed properties of the lubricant is to become absorbed by the fibres. The lubricant may comprise phenol, wax, fatty acid alcohol, stearate, calcium stearate, any fluoropolymer or a combination thereof, or any other suitable lubricant known to the skilled person.

Preferably, the addition of a combination of lubricants where one of the lubricants provides an internal lubricating effect can result in a more stable process and a faster extrusion rate. Internal lubricants typically have fairly short chains and preferably comprise fatty acid alcohols, calcium stearate, bisamide wax or any combination thereof. In particular, calcium stearate and bisamide wax demonstrate excellent fusion promotion without reduction in the melt viscosity of the concentrate. The inclusion of a coupling agent (such as a terpolymer or an ethylene terpolymer) enhances the physical properties of the composite, but reduces the extrusion rate. This reduction is countered by the inclusion of the aforesaid lubricants.

The present of the nitrogen blowing agent is to retain a specific gravity at or below 1.1. The use of a specific gravity at or below 1.1 is that it provides an end product with advantages not achieved by the use of higher specific gravity in the process. For example, the end product is lighter and therefore it is possible to increase the size of the end product without increasing the weight. For example, an end product produced by a process according to the present invention may have a weight of 80 kg, whereas a comparable volume of product produced in the absence of the nitrogen blowing agent may have an unblown weight of 90 kg. Further, the lighter end product is easier and safer to handle. Both of these benefits result in reduced distribution costs.

The process has a reduced cycle time and also less material is required in the production of the lighter end product. Therefore, the production process is cheaper and more efficient.

Further, the end product demonstrates increased sound insulation properties and increased heat insulation properties, thereby making it a more versatile product for onward use.

Another benefit to the end product is that it demonstrates increased dimensional uniformity, thereby providing increased and more uniform strength across the material.

The amount of blowing agent added is dependent upon the end use of the final product. For example, the more nitrogen blowing agent added, the more rigid or less flexible the end product. Preferably, the amount of nitrogen blowing agent added is between 0 and 0.15% by weight.

Optionally, ZnO or stearate may be added as an initiator to reduce the temperature of the nitrogen blowing agent.

The amount of coupling agent added is dependent upon the end use of the final product. Preferably, the amount of coupling agent added is between 0 and 205% by weight.

The proportion of natural fibres to other components during the blending process can significantly influence the properties of the end product of the method. Preferably, the proportion of natural fibres to polymers within the blend by weight is around 2:1. More preferably, the proportion of natural fibres to polymers within the blend by weight is 59:33.

Preferably, at step f, the blended mixture is heated to the melting point of the selected polymer to produce a dry-blend.

Preferably, the method further comprises the step of cooling the blended mixture.

The dry blend may be subjected to an extrusion process to produce pellets of reinforced composite in a polymer matrix.

Further, the extrusion process may include the step of heating the dry blend to a melting point of a selected thermosetting resin of said polymer during the extrusion process. Preferably, the extrusion process is conducted at a temperature of between 140° C. and 190° C. i.e. the melting point of the thermosetting resin for the selected polymer.

Preferably, the polymer is recycled polymer such as recycled HDPE. In a further embodiment, the polymer includes chain and/or network polymer. Preferably, the chain polymer includes a thermoplastic material. The chain polymer may comprise, but is not restricted to, one or more of polyethylene, polypropylene, polypropylene grafted with maleic anhydride, halogenated polyethylene, polyvinyl chloride. However, it is to be appreciated that any other suitable thermoplastic known to the skilled person may be used as an alternative or in addition to those previously listed.

The network polymer may include thermosetting resin. The thermosetting resin facilitates the formation of the three dimensional network between the natural fibres and the thermoplastic material. The thermosetting resin is preferably a phenolic resin.

It is to be appreciated that talc may be optionally included in the process according to the invention as a nucleating agent.

A further aspect of the present invention provides a composite produced by a method according to a first aspect of the present invention.

A further aspect of the present invention provides a composite comprising a natural fibre containing material, a polymer, a nitrogen blowing agent, and a lubricant.

In one embodiment, the composite further comprises a coupling agent. The coupling agent may comprise any suitable coupling agent such as, but not restricted to, glycidyl methacrylate.

In one embodiment, the natural fibre comprises rice husk fibre.

In a further embodiment, the natural fibre consists of rice husk fibre.

In one embodiment, the polymer comprises high density polypropylene and/or methyl butadiene styrene.

In one embodiment, the nitrogen blowing agent comprises azodicarbonamide.

In a further embodiment of the invention, there is provided a modular construction member suitable for use in a modular construction system, formed from the composite as herein before described.

Preferably, the modular construction member weighs less than 25 kg.

In a further embodiment, the panels and/or beams and/or connector members are joined by slotting adjacent parts together.

In a further embodiment of the invention there is also provided a modular assembly comprising: first and second plate members; and means for providing a channel between at least part of one plate and said other plate wherein said first plate member has a base plate and at least one retaining means for retaining said second plate member on said first plate.

Preferably, this embodiment further comprises at least one sensor member inserted in said channel means and held between said first and second plates.

Preferably, said means for providing a channel is an at least one channel member within said base plate.

Further preferably, said sensor member is a sensor suitable for measuring the weight of an article placed on the second plate of the modular construction.

In a further embodiment of the invention, the modular assembly as herein before described is formed from the composite described above.

### BRIEF DESCRIPTION OF THE DRAWINGS

An embodiment of the invention will now be described, by way of example only, and with reference to the accompanying drawing, in which:

FIG. 1 is a flow diagram representing a method of producing a reinforced composite containing fibre in a polymer matrix in accordance with a first embodiment of the present invention;

FIG. 2 is a perspective view of a panel formed from a reinforced composite;

FIG. 3 is a perspective view of a pillar formed from a reinforced composite;

FIG. 4a is a perspective view of a connector member holding three pillars of FIG. 3;

FIG. 4b is a view of the connector member of FIG. 3a before a pillar is inserted into the connector;

FIG. 5a is a cross-sectional view of the base plate of a weighing assembly;

FIG. 5b is a top perspective view of the base plate of a weighing assembly;

FIG. 6 is a top perspective view of a top plate for use in a weighing assembly;

FIG. 7a is a cross-sectional view of a fully assembled weighing assembly;

FIG. 7b is a top perspective view of a fully assembled weighing assembly.

### DETAILED DESCRIPTION OF THE INVENTION

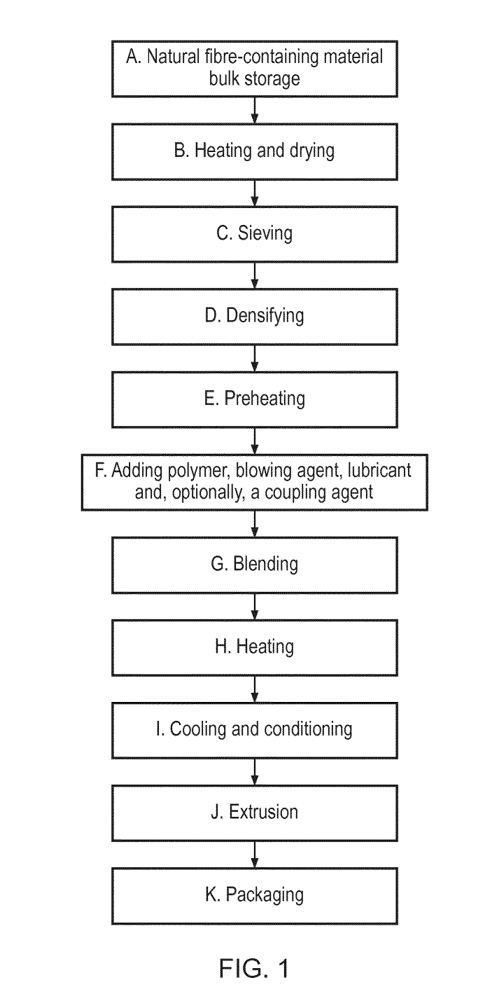

A method of producing reinforced composite containing rice fibre in a polymer mix according to an embodiment of the present invention will now be described with reference to the flow diagram in FIG. 1.

The first step in the method comprises the collection and bulk storage of natural fibre-containing material, in this embodiment rice husk material was used (step A). This is typically collected and stored in bins, silos or any other suitable container at ambient temperature.

After collection, the rice husk material is heated to remove moisture content within the rice husk material and soften the lignin within the rice husk material (step B). This is typically carried out by feeding the rice husk material into a hot blending chamber through a feeding hopper. The use of a hot blending chamber allows a stable and uniform temperature to be achieved throughout the chamber thereby assisting the drying process. Spiral ribbons within the chamber move the rice husk material in opposing directions thereby distributing the heat evenly throughout the rice husk material in the chamber. The drying process is considered to be complete when the temperature in the chamber reaches about 110° C.—at this temperature, any moisture or volatile fluids likely to be present in the rice husk material will have been eliminated. The drying process is typically carried out in a drum drier or any other suitable heating facility known to the skilled person. The heating step is a continuous process and the length of time taken for the drying step is dependent upon the moisture content of the incoming rice husk material.

One of the beneficial effects of heating the rice husk material at the temperatures used in the drying step is that the temperatures are sufficient to soften the lignin within the rice husk material, which significantly facilitates the next step in the method i.e. the sieving of the rice husk material.

The dried rice husk material is transported to a sieving apparatus (Step C) to segregate the rice husk fibre from any unwanted foreign material or contaminants that might be present. The sieving apparatus includes a vibrating stainless steel wire mesh sized so as to retain the rice husk material on the top of the mesh whilst allowing any unwanted material or contaminants to pass through. The fibrous nature of the rice husk material means that it is bigger in size and therefore retained on the upper side of the mesh during the vibration process, whilst any unwanted foreign material and contaminants are agitated free of the rice husk material and pass through the mesh. The mesh size used is dependent upon the incoming size of the rice husk material. For example, a typical mesh that might be used is 2 mm square wire mesh. The rice husk material is then guided from the top of the mesh to a collector ready for the next step in the process, the densifying step.

The sieving step produces a loose, soft, dry and clean rice husk material which has the beneficial effect of reducing the time required to carry out the densification step, thereby enhancing the efficiency of the process.

The densification step (Step D) involves the shredding of the rice husk material. This involves passing the rice husk material over a cutting assembly followed by a shredding assembly (comprising a specialist knife blade rotor). This results in abrasion of the rice husk fibre strands into shorter lengths, further softens the rice husk fibre lignin and further eliminates any residual contaminants or potentially volatile substances.

The densification step is complete when the rice husk fibre temperature reaches 100° C. which typically occurs after around 30 minutes. After subsequent cooling, the resultant densified rice husk fibres are perfectly dry and very fine in texture.

The next step (Step E) is to preheat the densified rice husk fibres, typically in a rotary mixer in preparation for the blending step (Step F). The rotary mixer is initially set to mix at a low speed and the mixing temperature is carefully regulated during the pre-heating step to reach a temperature of around 100° C. This preheating step allows any moisture that may be present in the densified rice husk fibres, for example, as a result of the way it has been stored, to be eliminated. In addition, this preheating step during mixing ensures a thorough blending of the fibres.

After reaching a temperature of around 100° C., the blending step (Step F) commences with the addition of a suitable mixture of polymer and resin to the densified rice husk fibres, followed by lubricant, to act as a dispersion agent, blowing agent and coupling agent.

During the blending step, the natural fibres mix with the polymers and the lubricant and other ingredients within the rotary mixer. This mixing action results in heat generation through the shear action of the mixing process. In addition, heat is also supplied during the blending step. The mixing action continues until the temperature of the mixture reaches that of the melting point of the thermosetting resin. This melting point temperature is dependent on the thermosetting resin used, but is typically between 140° C. and 190° C.

### Extrusion

The blending of the densified rice husk fibres with the resin and lubricant and other ingredients at elevated temperatures followed by subsequent cooling in a cooling chamber for at least 30 minutes produces a dry fibre in a semi-crumb form. However, in order to achieve a fibre that is optimised for later extrusion processing, it is desirable to further condition the dry fibres at ambient temperature, preferably for around 24 hours (Step I). This ambient temperature treatment results in a more stable extrusion process. This additional conditioning time facilitates the diffusion of the lubricant into the rice husk fibres thereby reducing its lubricating effect during feeding into the extrusion feed hopper.

After conditioning at ambient temperature, the blended material in semi-crumb form is extruded in a conventional manner to produce pelletised product. This involves continuous feeding the rice husk fibre through a hopper into an extruder, typically a screw extruder at a predetermined barrel zone temperature of 140° C.-190° C. and die zone temperature of 110° C.-130° C. In addition, the fibres are heated to the melting point of the selected resin. It is to be appreciated that this temperature will vary, typically between 130° C. to 190° C., depending on the specific resin used.

The single screw or double screw extruder torque level is preferably maintained at 20 to 40% of set speed.

The shearing forces to which the fibres are subjected to under controlled conditions during the extrusion process facilitates the realignment of the geometry of the fibres. Where the preferred extruded product is pellets, a perforated plate is provided at the extruder outlet and the extruded product (in the form of multiple extruded strands) is cut on emergence from the die head by rotating knives to form face-cut pellets. The resulting pellets are prevented from sticking together by providing an air spray during cutting to cool the extruded pellets.

Further processing of the extruded pellets is possible either by further extrusion or injection, depending on the desired product and application of the fibrous material. Alternatively, the pelletised product may be packaged and stored or transported for onward use.

One example of the components that may be used in the above embodiment are as follows:

| Component | % by Weight |
|---|---|
| Rice husk | 58.5 |
| High density polyethylene | 32.5 |
| Resin | 2.0 |
| Wax | 2.0 |
| Azodicarbonamide | 0.5 |
| Methyl butadiene styrene (lubricant) | 2.0 |
| Glycidyl methacrylate | 2.5 |

The embodiment described above uses only rice husk rather than a blend of fibres. This allows the process to be carried out where only rice husk is available locally whilst avoiding the need to source and transport other fibre types to the point of rice husk processing, or the exportation of the rice husk to a non-local point of processing.

However, it is to be appreciated that the method of the present invention could be carried out using a combination of natural fibres including kenaf and palm fibre.

The presence of the nitrogen blowing agent assists the method of the present invention in utilising rice husk alone. In the embodiment described above, the nitrogen blowing agent used is azodicarbonamide, which is added at the blending stage (Step G) as a weighted amount of pellets or powder.

The addition of a nitrogen blowing agent facilitates the maintenance of a specific gravity at or below 1.1.

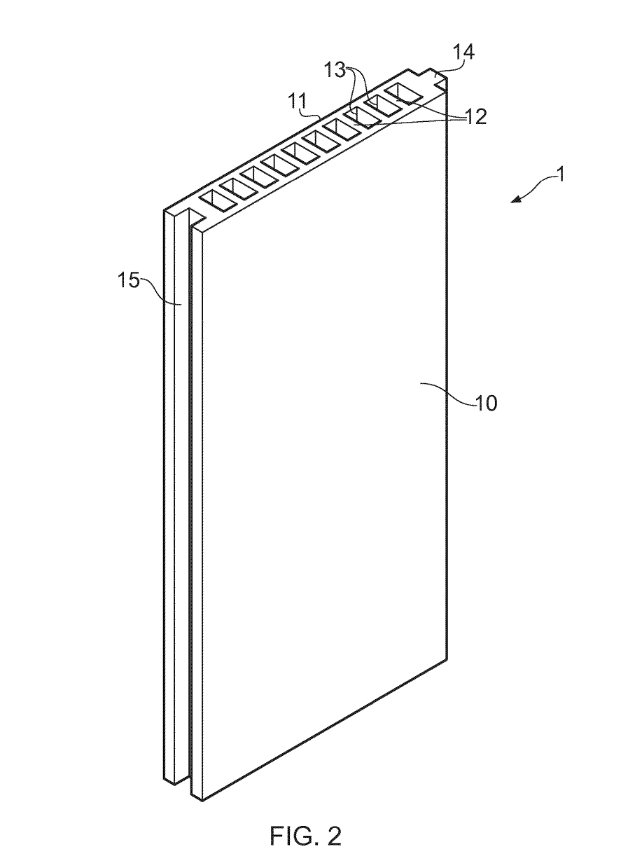

In an embodiment of the invention, the extruded pellets are further processed and are subsequently formed into panels, pillars, beams and connector members or other modular construction elements for use in different types of modular constructions. A typical panel 1 that can be formed from the material is shown in FIG. 2.

As illustrated in this figure, the panel 1 has a rectangular front face 10 and rectangular rear face 11. The faces 10 and 11 are substantially parallel and are joined by internal members 12. These internal members define inner channels 13 between the two faces 10 and 11. The internal members 12 provided stability to the panel 1, whilst the inner channels 13 mean that the panel 1 maintains a light weight which is particularly desirable when the panel 1 is used in modular constructions

Down the length of one long side of the panel 1 is an insertion slot 15, on the other long side of the panel 1 is slot insertion member 14. When the panel is used in a construction, insertion member 14 is inserted into slot 15 of an adjacent panel, to hold the two adjacent panels together. Using this method of construction avoids the need for screws, nails or other additional materials to fix two panels together.

Of course, in other embodiments of the invention, panel 1 may be formed from only one section with a front and rear face with no inner channels. Furthermore, the panel may not be rectangular, but may be of other shapes that can slot together using the insertion slot and corresponding insertion member. Furthermore, the slot 14 may not extend down the entire length of the panel member, instead, there may a single smaller slot, somewhere along the length of the side of the panel, or there may be a series of slots distributed down the length of the side of the panel. Preferably, the size of the panel will be determined according to the ultimate use of the panel, but typically the panels are between 0.5-1.5 m wide and 1-2.5 m tall.

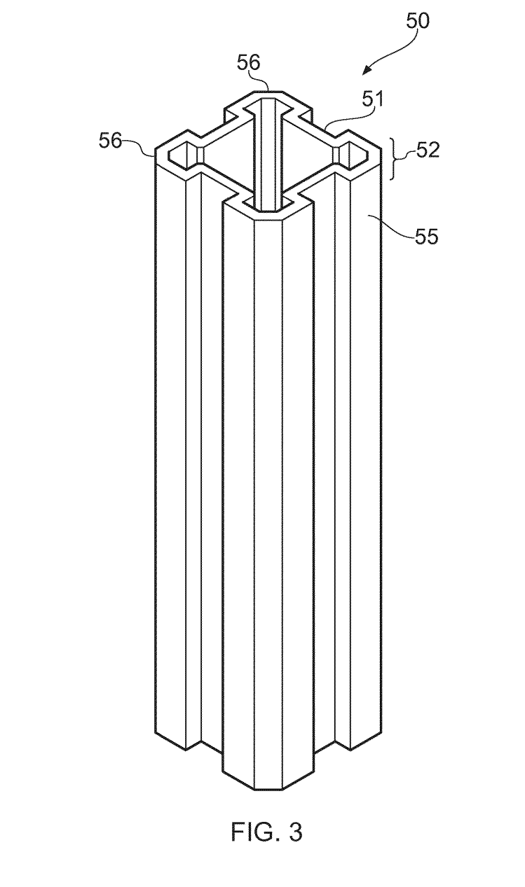

FIG. 3 shows a vertical pillar member 50 that can be used to join panels 1 together at a desired angle, in this case, the angle is 90° or 180°. In this embodiment, the pillar 50 is hollow and has an approximately square cross-section formed from four faces 55. The centre of each face 55 is provided with an insertion slot 51, extending substantially vertically into the hollow body of the pillar 50 for receiving an insertion member 14 of panel 1. Each face 55 is joined by a corner member 52, which is shaped to provide a chamfered corner 56; however the corner member may alternatively be curved, or may be a standard 90° corner. In this embodiment the insertion slots 51 are in the centre of each of the four faces 55 of the pillar 50, however, the pillar 50 may have three faces (joined with corner members so that the angle between adjacent faces is at 120°), or five or more faces (so that the angle is 72° or less). Furthermore, in certain embodiments, not all of the faces of the pillar may be provided with insertion slots 51. Preferably the slots 51 run down the entire length of the face 55 of the pillar 50 in which they are provided, but they may only run along part of the length of the face of the pillar. Again, the size of the pillar 51 will be determined by the ultimate use for the pillar 51 and it will preferably be sized to match the panels it will be used in conjunction with. The slots 51 provided within the pillar 50 will be configured to match the arrangement of the insertion members 14 of the panel 1 that will be received in the slot 51.

In this embodiment, the pillar 50 can connect with up to four separate panels 1 for use in a modular construction, for example, to provide internal separation between rooms within a construction. Again, the pillar 50 and panels 1 fit together by simply inserting the insertion members 14 into the slots 51, so no extra fixings such as screws, or nails are necessary.

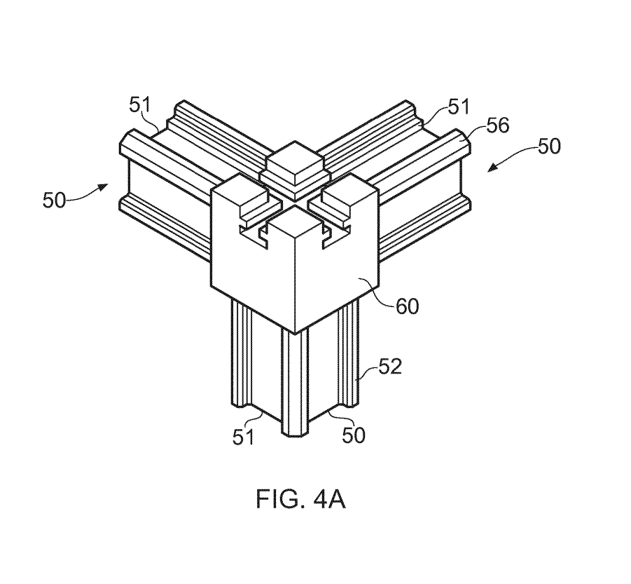

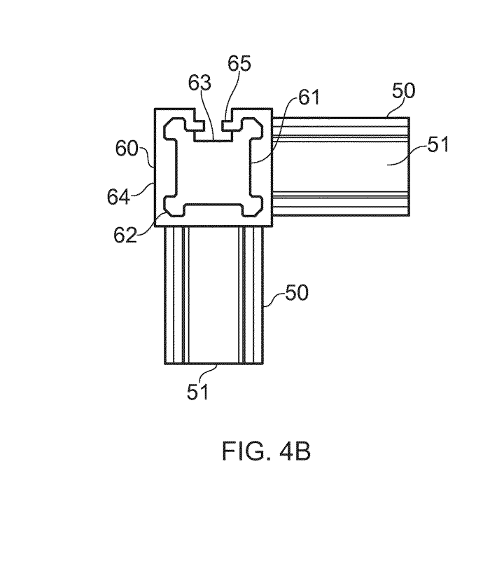

FIG. 4a is a perspective view that shows a connector member 60 connected to three pillars 50. The pillars 50 are all held within the connector member at 90° to each other. FIG. 4b is an alternative view showing the opening in connector member 60 into which an end of pillar 50 is inserted. It is apparent that the interior perimeter 61 of connector member 60 is shaped to so that the pillar 50 can be inserted into and held by the connector member 60. One of the faces of inner perimeter 61 has a protrusion 63 which is shaped to match with the shape of insertion slot 51, so that the protrusion 63 will be snugly received within the insertion slot 51 of a particular face of the pillar 50, when the pillar 50 is inserted into the connector member 60. For the remaining faces of the pillar 50 the rear faces of the insertion slots 51 will not touch the interior perimeter 61 of connector 60 but will instead be parallel to the interior perimeter 61.

FIG. 4b also shows the outer perimeter 64 of connector member 60. This is provided with an insertion slot 65 for receiving an insertion member 14 from a panel 10. In this way, the connector members 60, panels 1, and pillars 50 all cooperate to form a stable modular construction.

Furthermore, although not illustrated, the reinforced composite can also be used for other modular elements such as frames for door openings, windows, bunks, shelves, cupboards or worktops. These other modular elements may include different types of connectors for connecting more than four pillar members (e.g for connecting six or eight pillars members) where the angle between each member may be the same or different. A modular element may be provided that fits snugly around the circumference of a pillar member, to allow the pillar to be connected to a panel, or another connector member for example. The modular element may alternatively be an edge element, that connects to another element to provide an edge with a particular profile, such as a curved or tapered or square for example.

These other modular elements will also be provided with slots and insertion members as necessary to allow them to cooperate with all of the other elements in the modular construction.

Typically all of the different elements described above for use in modular constructions are lightweight, and no single element will weigh more than approximately 25 kg. This makes the elements extremely useful for situations when the construction has to be formed quickly, or where there may only be one or two people available to make the modular construction. The modular constructions may be particular useful as temporary accommodation, after an earthquake for example, or for use in remote locations where it is not easy to transport the materials that would be required for a standard construction. The modular construction may alternatively be used for low cost housing in areas of the world where there is a requirement for such housing. The modular constructions are also extremely easy to assemble and no special skills are required to allow someone to assemble a modular building using the various elements.

The reinforced composite as hereinbefore described can also be used in the formation of a weighing assembly as described in more detail below. Again, the extruded pellets as described above will be further processed to form the components of the weighing assembly.

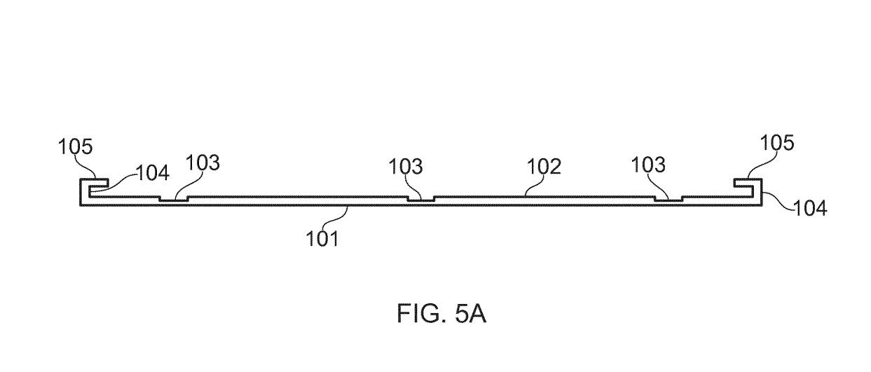

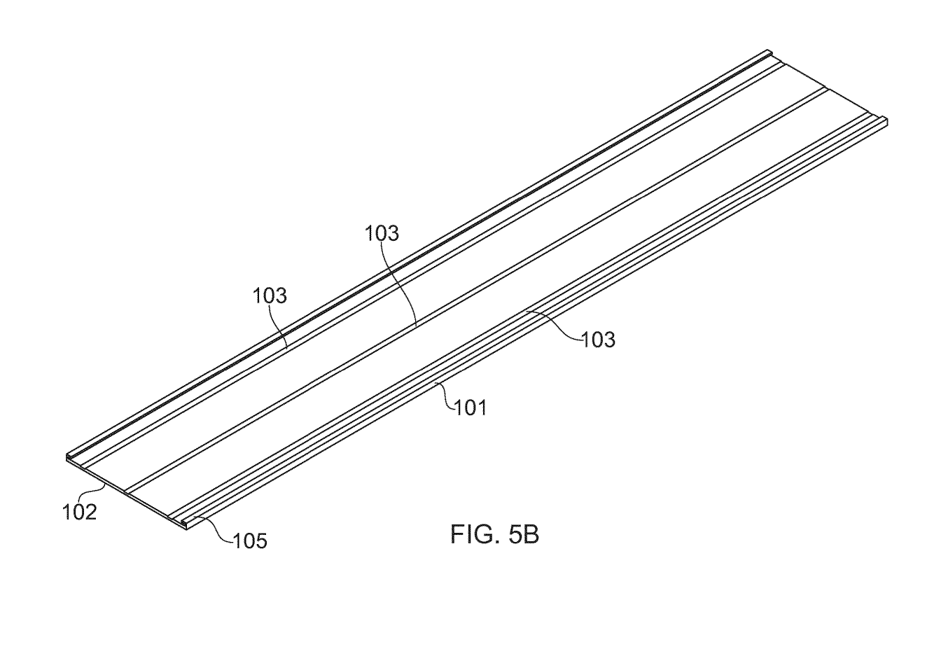

FIGS. 5a and 5b show cross-sectional and top perspective views of a base section 101 as used in a weighing assembly 100. As shown in the figures, the base section consists of central plate 102 with arms 104 extending substantially vertically upwards from the long edges of plate 102. Retaining lips 105 extend substantially horizontally inwards from the arm 104, parallel to the central plate 102 As shown, the arms 104 and lips 105 extend along the entire length of the central plate 102, on both long sides of the plate. In other embodiments of the invention arms 104 and lips 105 may only extend part way along the length of the central plate 102, or they may be arranged as a series of arms 104/lips 105 along the length of the edges of central plate 102 with gaps between each arm/lip. Also shown in these figures are channels 103. As illustrated, there are three parallel channels in the central plate 102 running substantially along the length of the plate 102. Again, in other embodiments of the invention there may be a one or more channels, and they may not extend along the entire length of the central plate 102. Preferably, the central plate 102 is substantially rectangular, but it may be square, or any other shape. It simply needs to be shaped so that it can easily be inserted where required.

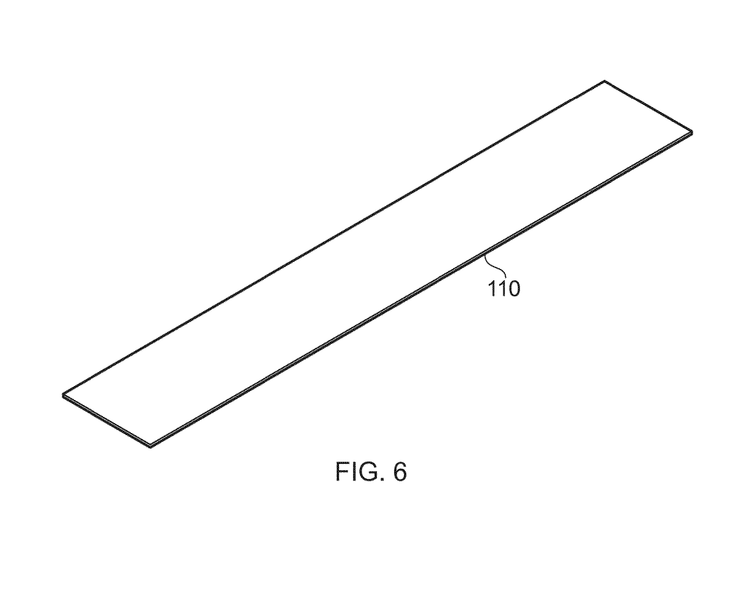

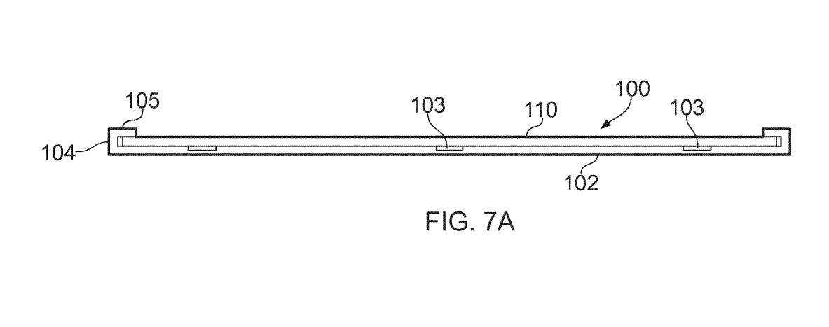

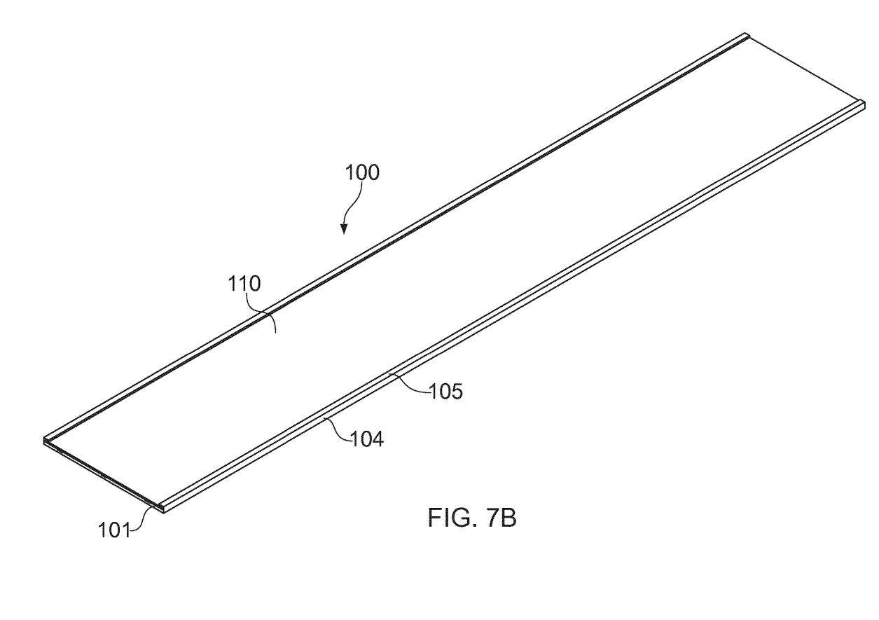

FIG. 6 shows a top plate 110, and FIGS. 7a and 7b show the top plate 11-when it has been inserted over the central plate 102 and is then held in place by the arms 104 and lips 105. Clearly, the top plate 110 will be sized so that it is a snug fit over the central plate 102 and will be held securely in place by arms 104 and lips 105.

Channels 103 are provided to allow weight sensors to be provided in the channel. These are placed in one or more of the channels 103 before the top plate 110 is placed in position. One the sensors are secured in position in the channel(s) 103, top plate 110 can be secured in position to complete the assembly 100.

In an alternative embodiment of the invention, the top plate 110 may be held above the central plate 102 so that it effectively floats in the weighing assembly 100, and does not contact the central plate 102, so that there is a gap between the two plates 102 and 110. Typically, the gap will be 2 mm high, but this is merely an example, and it may be lower or higher than this. In this way, sensors can be inserted into the gap between the plates 102 and 110 to allow the assembly to be used to weight articles loaded onto the top plate 110.

In the invention, the top plate 110 is designed so that the front and rear faces of the plate are substantially identical. In this way, if one surface of the plate 100 becomes worn, or damaged or abraded during use of the assembly 100 the top plate 110 can simply be slid out of the assembly, turned over and then slid back into position over the central plate 102. In this manner, the base section 101 does not have to be taken out of position. This is particularly useful if the base section has been fixed into position within a structure. The base section 101 may simply be slotted into position on a floor, between other panels that will form the floor, or it may be screwed, nailed glued, or fixed by other means to the floor.

The weighing assembly 100 can be used in the lining of air freight containers, in vehicle interiors or used in continuous weighing systems. The assembly can be used for the weighing of solids, liquids and gases including but not limited to materials such as cement, alcohol, soft drinks, water, oxygen or acetylene. The weight sensors are standard and are connected to a display or central computer system so that the operator can easily see the weight of the item on the weight assembly. Alternatively, the weight sensors may radio a signal to a central receiving station, so that the weight of the load in any part of a vehicle for example can be read at the central receiving station whether the vehicle concerned is moving or at rest.

As herein before described the panels and connector members are formed of the reinforced composite as described in more detail in the specification. However, in alternative embodiments of the invention, the panels, connectors and weighing assembly may be formed from other plastic or composite materials.

Although aspects of the invention have been described with reference to the embodiments shown in the accompanying drawings, it is to be understood that the invention is not limited to the precise embodiment shown and that various changes and modifications may be effected without further inventive skill and effort.

1. A method of producing reinforced composite containing fibre in a polymer matrix comprising the steps of:
a. heating and drying a natural fibre-containing material in a hot blending chamber;
b. sieving the dried natural fibre-containing material to produce a loose, soft and clean natural fibre free of contaminants and unwanted elements;
c. shredding the fibre;
d. pre-heating the shredded fibre;
e. blending polymer, a nitrogen blowing agent and a lubricant with the shredded fibre; and
f. heating the blended mixture to the melting point of the polymer.

2. A method according to claim 1, wherein a coupling agent is also added at step e.

3. A method according to claim 1, wherein the natural fibre containing material comprises rice husk fibre.

4. (canceled)

5. A method according to claim 1, wherein the nitrogen blowing agent is azodicarbonamide.

6. A method according to claim 1, wherein the blending step is carried out at a specific gravity at or below 1.1.

7. A method according to claim 1, further comprising the step of cooling the blended mixture to provide a dry blend.

8. A method according to claim 7, further comprising the step of subjecting the dry blend to an extrusion process to produce pellets.

9. A method according to claim 8, wherein the extrusion process includes the step of heating the dry blend to a melting point of a selected thermosetting resin of said polymer during the extrusion process.

10. A method according to claim 1 wherein the rice husk material is heated in a hot blending chamber to about 110° C.

11. A method according to claim 1, wherein the shredding is activated at about 100° C.

12. A method according to claim 1, wherein the shredding produces a substantially short and soft fibre lignin.

13. A method according to claim 1, wherein the fibre is pre-heated in the blending means to around 100° C.

14. A method according to claim 13, wherein the mixture is heated to between around 140° C. and 190° C. during the extrusion process.

15. A method according to claim 1, wherein the polymer includes chain and/or network polymer.

16. A method according to claim 15, wherein the chain polymer includes thermoplastic material.

17. A method according to claim 15, wherein the network polymer includes thermosetting resin.

18. A method according to claim 1, wherein the lubricant comprises wax, fatty acid alcohol, stearate or a combination thereof.

19. (canceled)

20. A composite comprising a natural fibre containing material, a polymer, a nitrogen blowing agent, a lubricant and optionally a coupling agent.

21. A composite according to claim 20, wherein the natural fibre comprises rice husk.

22. A composite according to claim 21, wherein the natural fibre consists of rice husk.

23. A composite according to claim 20, wherein the polymer comprises high density polypropylene and/or methyl butadiene styrene.

24. A composite according to claim 20, wherein the nitrogen blowing agent comprises azodicarbonamide.

25. A composite according to claim 20, wherein the coupling agent comprises glycidyl methacrylate.

26. A modular construction member suitable for use in a modular construction system, wherein the modular construction member is constructed using the composite of claim 20.

27. A modular construction member according to claim 26 wherein the modular construction member is a connector member for use in a modular construction system.

28. A modular construction member according to claim 26 wherein the modular construction member is a panel or beam suitable for use in a modular construction system.

29. A modular construction member according to claim 26 wherein the modular construction member weighs less than 25 kg.

30. A modular construction formed using one or more panels and/or beams as claimed in claim 28.

31. A modular construction according to claim 30 further comprising one or more connectors according to claim 27.

32. A modular construction according to claim 30 or 31 wherein the panels and/or beams and/or connector members are joined by slotting adjacent parts together.

33. A modular construction according to claim 30 wherein the modular construction is an emergency housing shelter or as low cost housing.

34. A modular construction according to claim 30 wherein the modular construction is a temporary construction.

35. A modular construction according to claim 30 wherein the panels and/or beams and/or connector members are configured within the construction when assembled so that the construction can be easily extended if required.

36. A modular construction according to claim 30 wherein the modular construction is fire-resistant.

37. A modular assembly comprising:
first and second plate members; and means for providing a channel between at least part of one plate and said other plate wherein said first plate member has a base plate and at least one retaining means for retaining said second plate member on said first plate.

38. A modular assembly according to claim 37 further comprising at least one sensor member inserted in said channel means and held between said first and second plates.

39. A modular assembly according to claim 37 wherein said means for providing a channel is an at least one channel member within said base plate.

40. A modular assembly according to claim 38 wherein said sensor member is a sensor suitable for measuring the weight of an article placed on the second plate of the modular construction.

41. A modular assembly according to claim 37 wherein said second plate has substantially identical front and rear faces, and can be held by said retaining means with either face facing the base plate of said first plate member.

42. A modular assembly according to claim 39 wherein said base plate is substantially rectangular and said at least one channel member extends along substantially the length of said base plate

43. A modular assembly according to claim 41 further comprising at one or more substantially parallel channel members.

44. A modular assembly according to claim 37 wherein said at least one retaining means comprises at least one arm extending substantially vertically upwardly from an outer edge of said base plate, and a lip extending substantially horizontally inwardly from said arm parallel to said base plate.

45. A modular assembly according to claim 44 wherein said base plate is substantially rectangular, and said retaining means are provided along at least some of both long edges of said base plate.

46. A modular assembly according to claim 45 wherein said retaining means extend along substantially all of the long edges of said base plate.

47. A modular assembly according to claim 37 wherein the first and second plate members are formed from the composite of claim 20.

48-49. (canceled)
